(19) United States
(12) Patent Application Publication
(10) Pub. No.: US 2008/0251320 A1
(43) Pub. Date: Oct. 16, 2008

(54) Energy-Absorbing Device

(75) Inventor: Pascal Lara, Nice (FR)

Correspondence Address: IPLM GROUP, P.A., POST OFFICE BOX 18455, MINNEAPOLIS, MN, 55418, US

(73) Assignee: Capital Safety Group EMEA, Carros (FR)

(21) Appl. No.: 11/910,042

(22) PCT Filed: Mar. 29, 2006
(86) PCT No.: PCT/EP06/61149

§ 371 Date: Sep. 28, 2007

(30) Foreign Application Priority Data
Apr. 1, 2005 (FR) 0550851

(51) Int. Cl. A62B 35/04; F16F 7/12; A62B 1/00

(52) U.S. Cl. 182/192; 188/374

(57) ABSTRACT

The invention relates to an energy-absorbing device for a safety fixing system, comprising two parts which can move frictionally in relation to one another such as to absorb energy. The invention is characterised in that the device comprises means for adjusting the frictional force between the two parts. The invention also relates to a safety fixing system comprising said energy-absorbing device. The invention is suitable for safety systems which, for example, make use of a lifeline.

This invention relates to an energy absorption device as well as a safety fixing system equipped with this device.

The invention is intended for use particularly in the field of safety installations which use life-lines by means of which personnel working in dangerous conditions are able to steady themselves.

The invention relates more particularly to safety fixing systems that enable impacts, due mainly to people falling in accidents, to be absorbed.

In this field, a safety anchoring device incorporating an energy absorber is known from document WO-A-01/87420.

Because of the different settings it provides (release and frictional force) the invention makes it possible to limit the falling forces exerted both on the user and on the structure, according to the thickness of the support and its strength.

According to this state of the art the energy absorption is provided by the plastic deformation of a helical element.

The remanent deformation exerted on the helical element provides the absorption of the energy generated in the event of an impact.

One disadvantage associated with this type of device is that it gives rise to remanent deformation of the helical element, which makes it impossible to re-use.

Moreover, the level of damping cannot be controlled by this type of device.

A safety anchoring device comprising a shock absorber, formed classically by an assembly of threaded rods supporting a nut and capable of translating, with a high degree of friction in a sleeve, the relative friction of the threaded rod with the nut and of the sleeve to provide an energy absorption capable of damping impacts, is also known from document WO-A-03/039680.

As in the previous case, no control of the damping is possible according to this prior art.

Furthermore, when it is released, the shock absorber is degraded, which reduces the possibilities of re-using it.

This invention enables some or all of the disadvantages of the aforementioned devices to be eliminated, and presents for this purpose an energy absorption device for an improved safety fixing system.

More particularly, the device proposed here comprises two sections that can be set in relative motion with a friction to absorb at least some of the energy generated in the case of impacts.

Setting means are advantageously provided to adjust the frictional force between the two sections capable of being set in relative motion.

In this manner the device of the invention can easily be configured to the particular application for which it is to be used.

The system for setting the frictional force is preferably designed so that the frictional force is continuously adjusted either up or down.

This variation is also provided, in a preferred manner, by modifying the force of contact between the two sections, i.e. by modifying the supporting force applied by one of the sections to the surface of the other section.

According to an advantageous variant of the invention the energy absorption device also comprises fuse means so that the relative movement of the two sections can only be triggered beyond a certain predetermined force threshold (advantageously the predetermined force threshold is selected in relation to the predetermined frictional force).

This therefore prevents any untimely release of the energy absorption system.

According to a further preferred variant, the energy absorption device is incorporated in a safety fixing system assuming the general form of a post exhibiting a body capable of pivoting relative to a base, and enabling persons to be connected to it by means of a life-line or anchorage point.

Other purposes and advantages will be indicated in the course of the following description, which is given by way of information and is not exhaustive as far as the invention is concerned.

This invention relates to an energy absorption device for a safety fixing system, comprising two sections capable of being set in relative motion with friction so that it is able to absorb energy, characterised in that one section comprises two jaws capable of being applied to various points on the other section.

In the preferred embodiments, this occlusive device is such that:
it comprises means for setting the frictional force between the two sections by varying the force of contact between the two sections.
the distance between the jaws is adjustable by screwing.
the other section comprises a portion of cable capable of being displaced between the jaws.
the jaws are provided with a groove for guiding the portion of cable.
the device comprises fuse means for triggering the relative movement of the two sections only beyond a predetermined force threshold.
the fuse means are two fuse parts immovably attached to each other by means of a threaded connection, each of them being integral with a different section and configured so that the threaded connection is broken beyond the predetermined force threshold.
the fuse parts have tearing strengths for different threads so that the breaking of the threaded connection is due to the tearing of the threads of a single fuse part.
the fuse parts are of materials of different mechanical strength.
at least one fuse part is replaceable.
the fuse part having the lowest tearing strength of its threads is replaceable.

The invention also relates to a safety fixing system provided with an anchoring base on a reference surface and means of connection to a life-line, characterised in that it comprises an energy absorption device between the base and the means of connection.

According to preferred variants, this system is such that:
the means of connection comprise a body mounted on the base and receiving the absorption device in its internal volume.
the system comprises:
   a first fuse part integral with the base and one end of the cable portion, the other end of the cable portion being integral with the body;
   a frame supporting two jaws capable of being applied at various points on the cable portion to exert a contact force;
   a second fuse part integral with the body and immovable attached to the first fuse part by a threaded fuse connection beyond a predetermined force threshold.
the second fuse part is mounted replaceably on the frame and the tearing strength of its threads is lower than that of the threads of the first fuse part.

The appended drawings are given as an example and do not limit the invention. They represent only one embodiment of the invention and allow it to be easily understood.

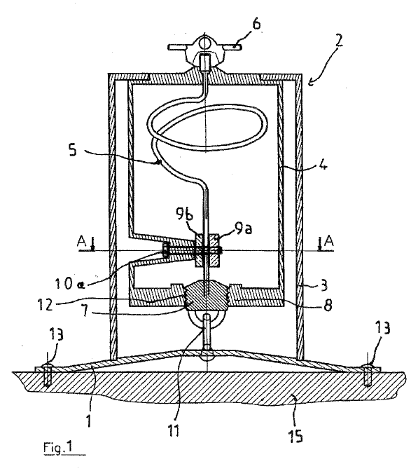

FIG. 1 is a longitudinal sectional view of a safety fixing system in an embodiment of the invention.

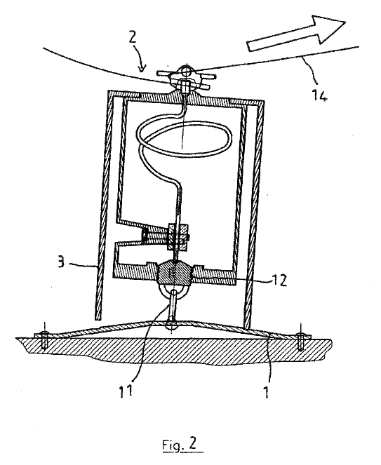

FIGS. 2 to 5 illustrate different operating phases of the invention when subjected to stress through an impact.

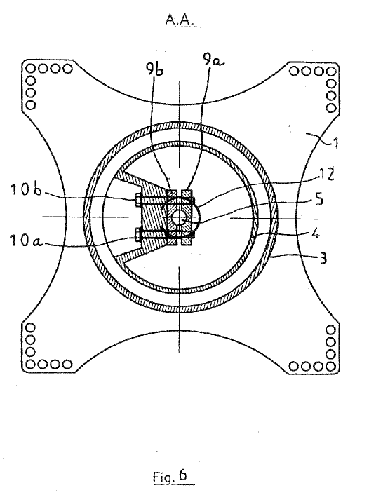

FIG. 6 is a sectional view along line A-A in FIG. 1.

The safety fixing system shown in the figures incorporates an energy absorption device comprising two sections capable of being set in relative motion with friction.

More particularly, in the case shown, the sections set in motion are a cable portion 5 on the one hand, and means 9a, 9b performing the function of a vice on the other.

In the case shown the frictional force between jaws 9a, 9b and cable portion 5 can easily be adjusted by means of screwing means 10a, 10b, for example screws that are shown in particular in FIGS. 1 and 6, so that jaws 9a, 9b are moved closer together or further apart to modify the force of contact between said jaws and cable portion 5.

The safety fixing system shown assumes the general form of a post provided with a base 1 capable of being fixed to a reference surface 15 (for example, a roof covering) by means of a plurality of screws 13 passing through holes shown, in particular, in FIG. 6.

Base 1 is mounted on a body 3 which constitutes the essential mechanism of means of connection 2 to a life-line 14. The life-line is connected by means of a ring 6 of conventional design.

Any means of connection of prior art between the system of the invention and a life-line 14 may be used without departing from the framework of the invention.

Body 3 is cylindrical in shape, for example, and defines an inner part receiving volume forming the energy absorption device.

In this context body 3 encloses a frame 4 which is immovably attached to body 3, e.g. by welding, frame 4 serving to support the vice formed by jaws 9a, 9b.

The upper end of cable portion 5 is embedded in body 3/frame 4 assembly, for example at the upper end of body 3.

The lower end of cable portion 5 is embedded in a part 7, itself immovably attached to base 1 by means of link assembly 11.

It will be noted that link assembly 11 provides a freedom of rotary movement of base 1 relative to part 7.

An intermediate section of cable portion 5, in the case shown close to part 7, is enclosed by jaws 9a, 9b to provide a relative force of contact capable of generating a friction when cable portion 5 is in motion relative to jaws 9a, 9b.

It will be noted that in the case shown a high residual volume exists inside body 3, which enables a long length of cable portion 5 to be stored.

In the lower section of frame 4 a threaded connection 12 enables part 7 to be assembled relative to frame 4.

In this context a second fuse part 8 is formed integrally with frame 4, with a threaded section capable of interacting with the threads of part 7 to provide the aforementioned connection 12.

According to the embodiment shown, the second fuse part 8 is formed in one piece with frame 4.

However, this part may be fitted as an addition, and advantageously so that it can be replaced.

A tearing strength of the threads for threaded connection 12 is selected so that it determines the release threshold of the energy absorption device.

Thus for any force lower than the threshold predetermined for threaded connection 12, the latter includes all the stresses and no relative movement is generated between jaws 9a, 9b and cable portion 5.

When this threshold is exceeded, for example in the case of a sudden impact due to the falling of a person, threaded connection 12 is destroyed, which provides a freedom of movement of cable portion 5 in jaws 9a, 9b.

The friction generated absorbs at least part of the energy due to impact.

FIGS. 2 to 5 show different phases of mobilisation of the absorption device.

In the case of FIG. 2, therefore, an impact is generated and transmitted to the safety fixing system by means of life-line 14, connected to the system by means of connection 2.

At this level, slight tilting of body 3 may occur relative to base 1 because of link assembly 11 allowing such tilting to take place.

In the case of FIG. 2, the force is lower than the predetermined threshold so that threaded connection 12 remains intact.

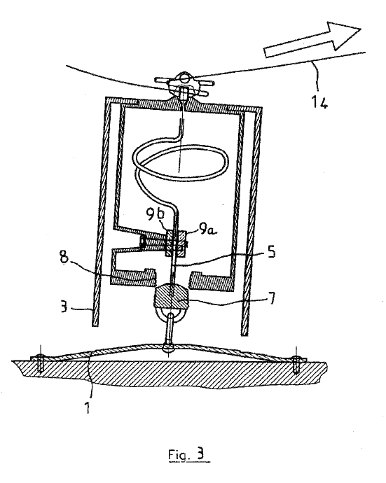

On the other hand, in the case of FIG. 3, the force is such that the threshold is exceeded and threaded connection 12 is torn.

Fuse parts 7 and 8 are then separated, which enables cable portion 5 to be displaced by sliding in jaws 9a, 9b.

Advantageously, each jaw 9a, 9b is provided with an inner groove, shown in FIG. 6, to provide good translational guidance of cable portion 5.

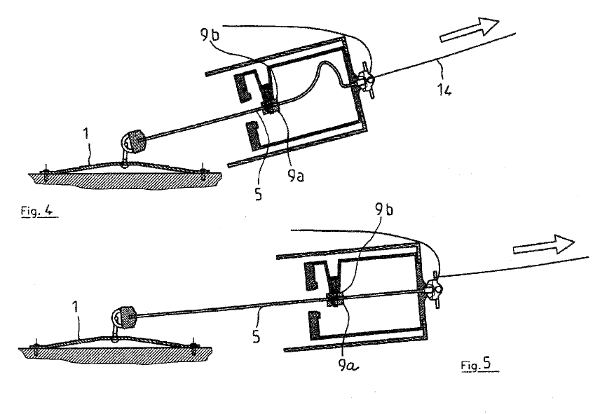

FIGS. 4 and 5 show the progression of the relative movement of cable 5 and jaws 9a, 9b.

During this movement, the friction generates an energy absorption (to absorb the impact), which also enables the forces acting on the receiving structure to be limited.

The level of damping can easily be adjusted by modifying the force of contact generated by jaws 9a, 9b on cable portion 5 by screwing or unscrewing screwing means 10a, 10b.

In the case of FIG. 5, cable portion 5 is fully tensioned, which stops the operation of the energy absorption device.

It will be noted that the fuse means described previously can be used independently of the energy absorption thus presented.

The fuse means are preferably configured so that they can easily be replaced without having to replace the fixing system in its entirety.

In this context, one of parts 7, 8 is advantageously produced in a material that is less tear resistant than the other in order to effect the destruction of the threads of only one of parts 7, 8.

Less resistant threads are preferably formed on part 8, and this part is provided detachably and replaceably on frame 4.

Other configurations, however, fall within the scope of the invention.

In particular, part 7 may be made replaceably in a material that is less resistant than part 8.

### REFERENCES

1. Base
2. Means of connection
3. Body
4. Frame
5. Cable portion
6. Ring
7. First fuse part
8. Second fuse part
9a, 9b. Jaws
10a, 10b. Screwing means
11. Link assembly
12. Threaded connection
13. Screw
14. Line
15. Reference surface

1. Energy absorption device for safety fixing system, comprising two sections capable of being set in relative motion with friction so that it absorbs energy, characterised in that
one section comprises two jaws (9a, 9b) capable of being applied on either side of the other section.

2. Device according to claim 1, wherein it comprises means of adjusting the frictional force between the two sections by varying the force of contact between the two sections.

3. Device according to claim 2, wherein the distance between the jaws (9a, 9b) is adjustable by screwing.

4. Device according to claim 1, wherein the other section comprises a cable portion (5) capable of being displaced between the jaws (9a, 9b).

5. Device according to claim 4, wherein the jaws (9a, 9b) are provided with a groove for guiding the cable portion (5).

6. Device according to claim 1, comprising fuse means for only triggering the relative movement of the two sections beyond a predetermined force threshold.

7. Device according to claim 6, wherein the fuse means are two fuse parts (7, 8) attached immovably by means of a threaded connection (12), and each integral with a different section and configured so that the threaded connection (12) is broken beyond the predetermined force threshold.

8. Device according to claim 7 wherein the fuse parts (7, 8) have tearing strengths of different threads so that the breaking of the threaded connection (12) is due to the tearing of the threads of a single fuse part.

9. Device according to claim 8, wherein the fuse parts (7, 8) are of materials of a different mechanical strength.

10. Device according to claim 7, wherein at least one fuse part is replaceable.

11. Device according to claim 8, wherein the fuse part having the lowest tearing strength of its threads is replaceable.

12. Safety fixing system provided with an anchoring base (1) on a reference surface (15) and means of connection (2) to a life-line (14), characterised in that
it comprises an energy absorption device according to claim 1 between the base and the means of connection.

13. System according to claim 12, wherein the means of connection comprise a body (3) mounted on the base ands receiving the absorption device in its inner volume.

14. System according to claim 13, comprising:
a first fuse part (7) integral with the base and with one end of the cable portion, the other end of the cable portion being integral with the body (3);
a frame (4) for supporting the two jaws (9a, 9b) capable of being applied at the various points of the cable portion in order to exert a contact force;
a second fuse part (8) integral with the body (3) and immovably attached by means of a threaded fuse connection (12) beyond a predetermined force threshold of the first fuse part (7).

15. System according to claim 14, wherein the second fuse part (8) is mounted replaceably on the frame (4), and wherein the resistance of its threads to tearing is lower than that of the threads of the first fuse part (7).

16. Device according to claim 2, wherein the other section comprises a cable portion (5) capable of being displaced between the jaws (9a, 9b).

17. Device according to claim 2, comprising fuse means for only triggering the relative movement of the two sections beyond a predetermined force threshold.

18. Device according to claim 3, comprising fuse means for only triggering the relative movement of the two sections beyond a predetermined force threshold.

19. Device according to claim 8, wherein at least one fuse part is replaceable.

20. Device according to claim 9, wherein the fuse part having the lowest tearing strength of its threads is replaceable.
